(19) United States
(12) Patent Application Publication
(10) Pub. No.: US 2025/0060727 A1
(43) Pub. Date: Feb. 20, 2025

(54) THREE-DIMENSIONAL PRINTING SEGMENTATION BASED ON ENVIRONMENT DATA

(71) Applicant: International Business Machines Corporation, Armonk, NY (US)

(72) Inventors: Carolina GARCIA DELGADO, Zapopan (MX); Jazmin RODRIGUEZ AGUILERA, Zapopan (MX); Jeremy R. FOX, Georgetown, TX (US); Sarbajit K. RAKSHIT, Kolkata (IN)

(21) Appl. No.: 18/451,093

(22) Filed: Aug. 16, 2023

(51) Int. Cl. G05B 19/4099; B29C 64/118; B29C 64/379; B29C 64/386; B33Y 40/00; B33Y 50/00

(52) U.S. Cl. CPC G05B 19/4099; B29C 64/118; B29C 64/379; B29C 64/386; B33Y 40/00; B33Y 50/00; G05B 2219/49023

(57) ABSTRACT

A platform may receive user printing information that identifies a first location of a first printer capable of printing a first portion of a three-dimensional item, a first printer type, and a first inventory of filaments. The platform may validate first environmental conditions of the first location and validate network printing information that identifies locations of a plurality of printers capable of printing three-dimensional items, printer types, inventories of filaments, and network environmental conditions of the locations. The platform may identify a second printer, of the plurality of printers, based on a distance between the first location and a second location of the second printer, the user printing information, the first environmental conditions, and the network printing information. The platform may determine a sequence between the first location and the second location for printing the first portion and the second portion based on the first speed and the second speed.

### BACKGROUND

The present invention relates to a three-dimensional (3D) printing process, and for example, to distributing the 3D printing process to multiple locations to improve a printing time of the 3D printing process. 3D printing is a process of manufacturing a 3D item from a model of the object (e.g., a computer aided design or a digital 3D model). 3D printing process involves providing material in successive layers to create the object.

### SUMMARY

A computer-implemented method, for three-dimensional printing segmentation, comprising receiving user printing information, associated with a first user, that identifies a first location of a first printer capable of printing a first portion of a three-dimensional item, a first printer type of the first printer, and a first inventory of filaments for printing using the first printer; validating first environmental conditions of the first location, that include a first level of humidity and a first temperature at the first location; validating network printing information, associated with a plurality of printers in a cloud environment that are capable of printing three-dimensional items, that identifies locations of the plurality of printers, printer types of the plurality of printers, inventories of filaments for printing with the plurality of printers, and network environmental conditions of the locations; identifying a second printer, of the plurality of printers, capable of printing a second portion of the three-dimensional item based on a distance between the first location and a second location of the second printer, the user printing information, the first environmental conditions, and the network printing information; determining a first speed of printing at the first location based on the first environmental conditions; determining a second speed of printing at the second location based on second environmental conditions of the second location; determining a sequence between the first location and the second location for printing the first portion and the second portion based on the first speed and the second speed; and causing the first portion and the second portion to be transported between the first location and the second location to cause the first portion and the second portion to be printed based on the sequence.

A computer program product comprising: one or more computer readable storage media, and program instructions collectively stored on the one or more computer readable storage media, the program instructions comprising: program instructions to receive user printing information that identifies a first location of a first printer capable of printing a three-dimensional item; program instructions to determine user environmental conditions, of the first location, that include a level of humidity and a temperature at the first location; program instructions to identify a second printer, of a plurality of printers in a cloud environment, based on an inventory of filaments at a second location of the second printer and a first distance between the first location and the second location; program instructions to identify a third printer, of the plurality of printers, based on an inventory of filaments at a third location of the third printer and a second distance between the first location and the third location; program instructions to determine a first printing time of the first printer and the second printer printing different portions of the three-dimensional item; program instructions to determine a second printing time of the first printer and the third printer printing different portions of the three-dimensional item; and program instructions to cause a first portion and a second portion, of the three-dimensional item, to be transported between the first location and the second location for printing based on the first printing time and the second printing time.

A system comprising: one or more devices configured to: receive a request associated with a first printer printing a three-dimensional item at a first location; identify a second printer, capable of printing the three-dimensional item, based on an inventory of filaments at a second location of the second printer and a first distance between the first location and the second location; identify a third printer, capable of printing the three-dimensional, based on an inventory of filaments at a third location of the third printer and a second distance between the first location and the third location; determine first environmental conditions at the first location, second environmental conditions at the second location, and third environmental conditions at the third location; determine a first printing time, of the first printer and the second printer printing different portions of the three-dimensional item, based on the first environmental conditions and the second environmental conditions; determine a second printing time, of the first printer and the third printer printing different portions of the three-dimensional item, based on the first environmental conditions and the third environmental conditions; and cause a first portion and a second portion, of the three-dimensional item, to be transported between the first location and the second location for printing based on the first printing time and the second printing time.

### BRIEF DESCRIPTION OF THE DRAWINGS

FIGS. 1A-1F are diagrams of an example implementation described herein.

FIG. 2 is a diagram of an example computing environment in which systems and/or methods described herein may be implemented.

FIG. 3 is a diagram of example components of one or more devices of FIG. 1.

FIG. 4 is a flowchart of an example process associated with 3D printing segmentation based on environmental data.

### DETAILED DESCRIPTION

The following detailed description of example implementations refers to the accompanying drawings. The same reference numbers in different drawings may identify the same or similar elements.

A component of a device may be manufactured using a 3D printing process. The 3D printing process may be performed in an environment. A quality of the 3D printing process and a speed of the 3D printing process may be based on a temperature of the environment, a level of humidity of the environment, a level of dust of the environment, and/or a level of electrostatic charge of the environment.

Typically, the environment is not a controlled environment. As a result, the quality of the 3D printing process and the speed of the 3D printing process may be inconsistent as a result of changes to the temperature, the level of humidity, the level of dust of the environment, and/or the level of electrostatic charge. The changes to the temperature may be dependent on a time of day, a season, and/or a geographical location. Accordingly, initiating the 3D printing process without considering the changes to the temperature mentioned above may cause the quality of the 3D printing process and/or may cause the speed of the 3D printing process to be increased.

The inconsistencies of the quality of the 3D printing process may cause 3D items to be printed multiple times to achieve a desired quality. Additionally, or alternatively, the inconsistencies of the speed of the 3D printing process may consume computing resources, networking resource, and/or storage resources as the speed of the 3D printing process decreases. Accordingly, a need exists to ensure consistency with respect to the quality of the 3D printing process and the speed of the 3D printing process.

Implementations described herein provide solutions to overcome the above issues relating to the inconsistency with respect to the quality of the 3D printing process and the speed of the 3D printing process. For example, implementations described herein are directed to improving the quality and the speed of the 3D printing process based on use of printers of a cloud environment, based on locations of the printers (e.g., geographical locations of the printers), and/or based on environmental conditions at the locations.

For example, implementations described herein are to a system that may determine a location of a user desiring to print a 3D item. The system may determine a printer type of a first printer at the location and an inventory of filaments for printing using the first printer. The filaments (3D printer filaments) may be material that is used to manufacture 3D items (e.g., by way of 3D printing). In some examples, the filaments may include thermoplastic material. For example, the filaments may include one continuous slender plastic thread. The printer may be part of a cloud environment. The system may determine environmental conditions at the location. The environmental conditions may include a temperature at the location, a level of humidity at the location, a level of dust at the location, and/or a level of electrostatic charge at the location. The system may obtain information regarding predicted environmental conditions at the location and may use the information to predict changes to the environmental conditions at the location.

The system may determine additional printers included in the cloud environment. The system may determine location of the additional printers, printer types of the additional printer, and inventories of filaments for printing using the additional printers. The system may determine environmental conditions at the locations. The system may obtain information regarding predicted environmental conditions at the locations and may use the information to predict changes to the environmental conditions at the locations.

The system may identify one or more printers, from the additional printers, which may be used to print the 3D item in conjunction with the first printer. In some examples, the one or more printers may be identified based on the one or more printers may be located within a distance threshold from the location of the first printer. Additionally, or alternatively, the one or more printers may be identified based on inventories of filaments for printing using the one or more printers.

The system may analyze item information to determine a manner for segmenting the item without affecting the functionality of the 3D item. The item information may identify a size of the 3D item, a shape of the 3D item, a complexity of the 3D item, among other examples. For example, based on the item information, the system may determine a first portion of the item that is to be printed and a second portion of the 3D item that is to be printed.

The system may perform an analysis to determine different paths between the locations of the printers. For example, a first path may include the location of the first printer and a location of a first one of the one or more printers. Additionally, or alternatively, a second path may include the location of the first printer and a location of a second one of the one or more printers. The system may determine a printing time of each path and an amount of resources consumed by each path.

The printing time may be based on a speed of printing of a printer. The speed of printing of the printer may be based on a temperature at a location of the printer. In this regard, as the temperature increase, the speed of printing may be increased.

A path may be changed in real time according to the environmental conditions at locations along the path. For example, if rain is predicted at a location, the system may determine that a level of humidity will increase at the location and, accordingly, the quality of the 3D printing process will decrease. In this regard, the system may recommend that the start of the 3D process be delayed.

The system may select a path associated with the shortest print time and/or associated with a highest quality. The system may cause the different portions to be transported between the different locations of a path to cause the different portions to be printed at the different locations, respectively.

By causing the 3D item to be printed as described herein, the system may ensure that the environment the 3D printing process is occurring in a controlled environment. The environment may be controlled by taking into consideration the environmental conditions at the different locations. Accordingly, the speed and the quality of the 3D printing process may be improved and maintained. While implementations are described herein in connection with a 3D printing process, implementations herein may be applicable to fourth-dimensional (4D) printing process.

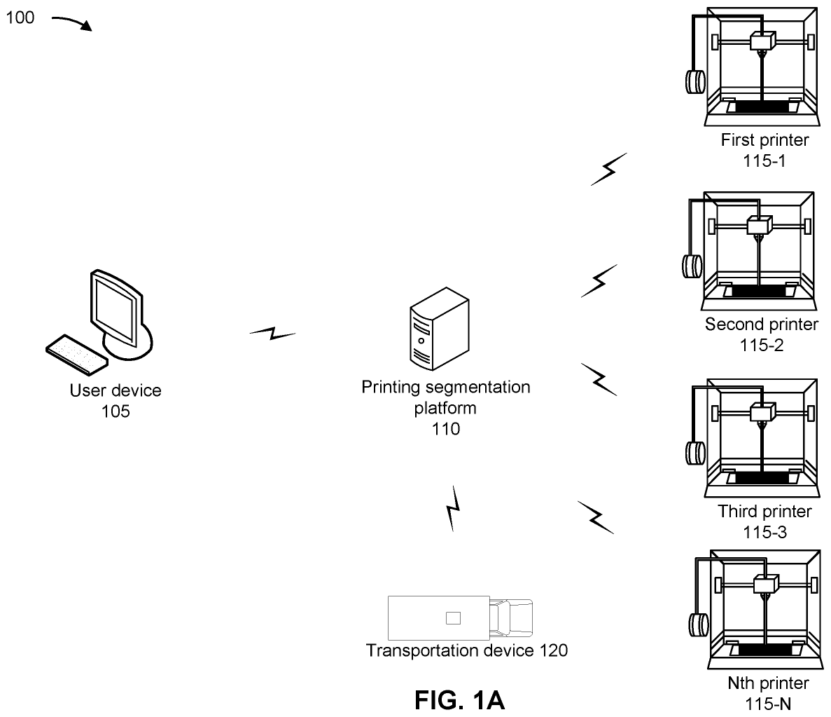

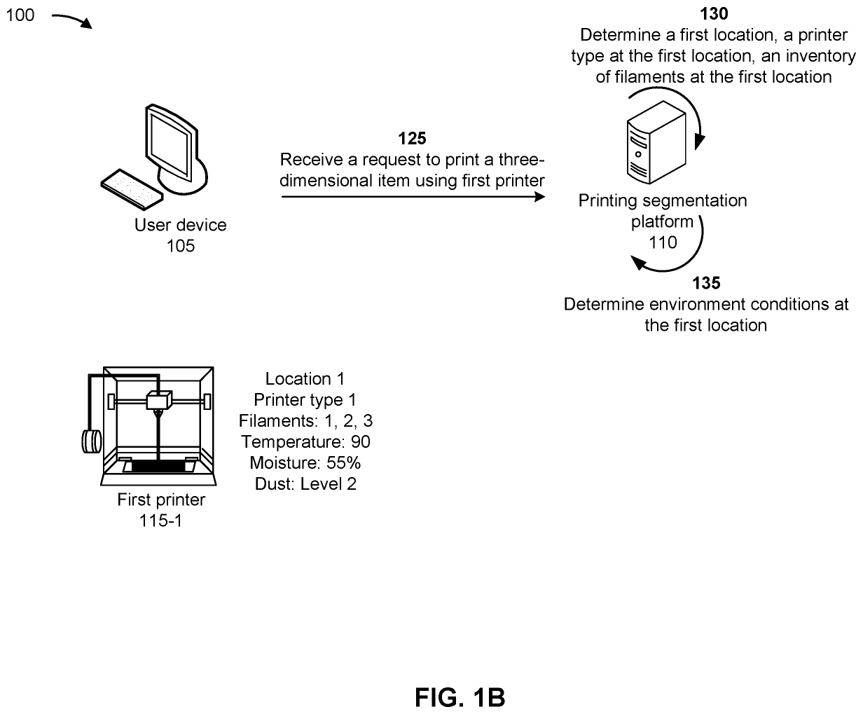

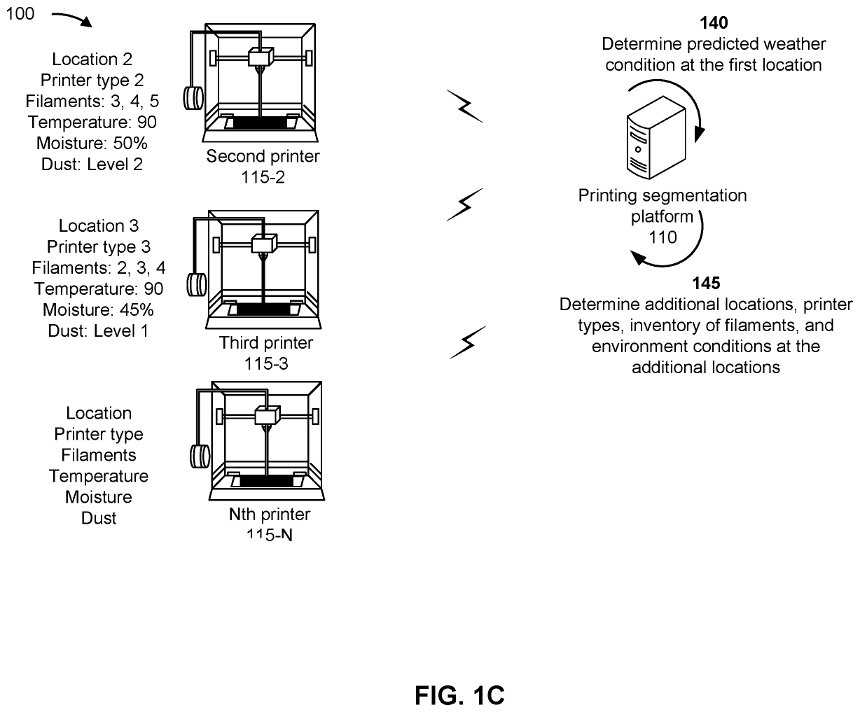

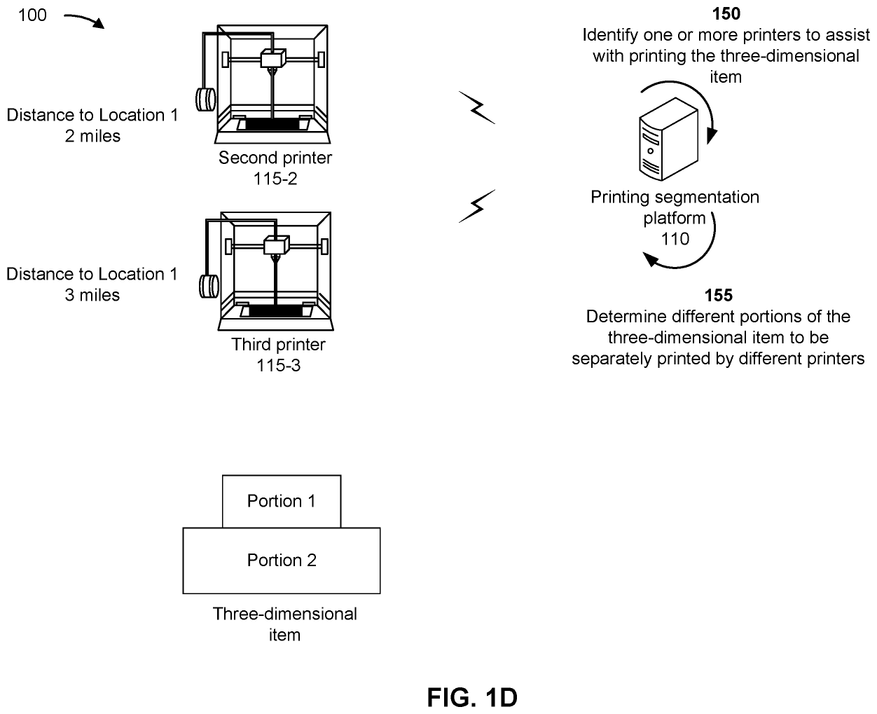

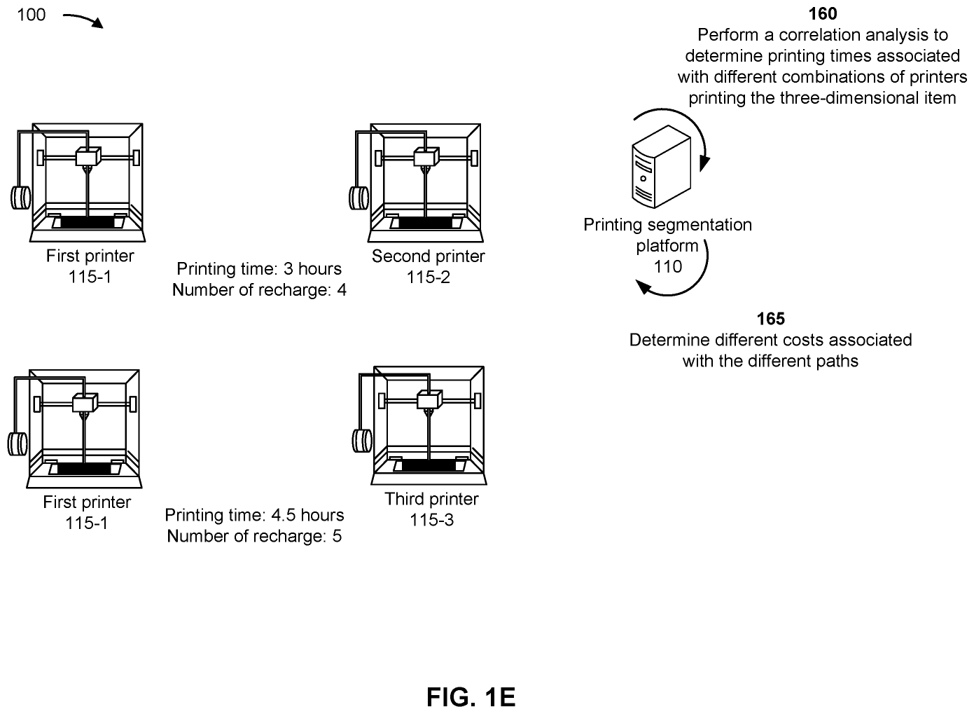

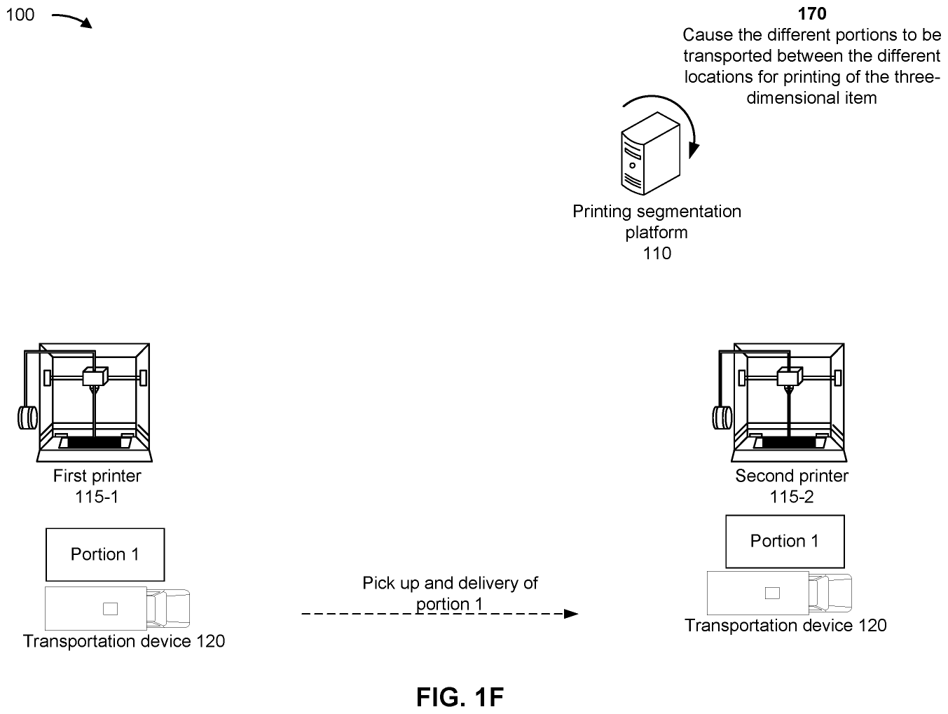

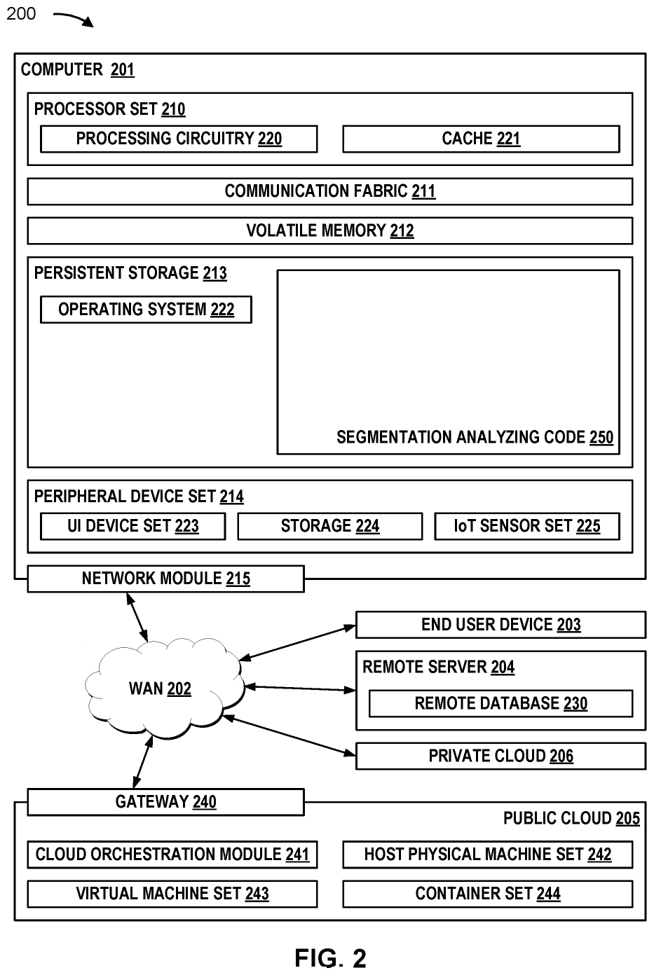

FIGS. 1A-1F are diagrams of an example implementation 100 described herein. As shown in FIGS. 1A-1F, example implementation 100 includes user device 105, a printing segmentation platform 110, a first printer 115-1, a first printer 115-2, a first printer 115-3 to nth printer 115-n (collectively printers 115 and individually printer 115), and a transportation device 120. These devices are described in more detail below in connection with FIG. 2.

User device 105, printing segmentation platform 110, printers 115, and transportation device 120 may be connected via wired connections, wireless connections, or a combination of wired and wireless connections. The devices may be connected via a network that includes one or more wired and/or wireless networks. For example, the network may include Ethernet switches. Additionally, or alternatively, the network may include a cellular network, a public land mobile network (PLMN), a local area network (LAN), a wide area network (WAN), a private network, the Internet, and/or a combination of these or other types of networks. The network enables communication between user device 105, printing segmentation platform 110, printers 115, and/or transportation device 120.

User device 105 may include one or more devices configured to receive, generate, store, process, and/or provide information associated with a 3D printing process, as explained herein. User device 105 may be used to provide printing information that may be used to fabricate a 3D item.

User device 105 may include a communication device and a computing device. For example, user device 105 may include a wireless communication device, a mobile phone, a user equipment, a laptop computer, a tablet computer, a desktop computer, and/or a similar type of device.

Printing segmentation platform 110 may include one or more devices configured to receive, generate, store, process, and/or provide information associated with segmenting the printing the 3D item, as explained herein. For example, printing segmentation platform 110 may identify printers 115 that are capable of printing the 3D item, identify different portions of the 3D item that may printed by different printers 115, identify different paths for transporting the different portions of the 3D item for additional printing (e.g., 3D printing), among other examples.

A printer 115 may include one or more devices configured to receive, generate, store, process, and/or provide information associated with segmenting the printing the 3D item, as explained herein. For example, the printer 115 may be configured to fabricate the 3D item by way of the 3D printing process discussed herein. In the example herein, printer 115 may be used to print the 3D item. Printers 115 may be included in a cloud environment.

Transportation device 120 may include one or more devices configured to transport different portions of the 3D item from one printer to another printer. For example, printer 115-1 may initiate printing of the 3D item by printing a first portion of the 3D item and transportation device 120 may transport the first portion to printer 115-2. Printer 115-2 may continue printing the 3D item by printing a second portion of the 3D item (e.g., on top of the first portion). Transportation device 120 may be configured to receive instructions from printing segmentation platform 110 to pick a portion of the 3D item from one printer 115 and to deliver the portion of the 3D item to another printer 115. Additionally, or alternatively, transportation device 120 may receive similar instructions from a printer 115.

Transportation device 120 may include a component that is used for picking up the portion of the 3D item. For example, transportation device 120 may include a suction component configured to suction the portion of the 3D item from a surface area of a printer 115 (e.g., a portion of a print bed of the printer 115). The print bed may refer to a surface, of the bottom portion of the printer 115, on which layers of the 3D item are printed. Transportation device 120 may be powered by a power source. The power source may include one or more batteries, one or more solar panels, among other examples.

As shown in FIG. 1B, and by reference number 125, printing segmentation platform 110 may obtain a request to print a 3D item using first printer 115-1. The request may include printing information for a 3D printing process to print the 3D item. In some implementations, printing segmentation platform 110 may obtain the printing information from user device 105. For example, user device 105 may provide the printing information as part of a request to print the 3D item.

The printing information may include information identifying first printer 115-1 and/or information identifying a user of user device 105. In some implementations, the printing information may include information regarding a 3D model of the 3D item. As an example, the printing information may include a 3D model of an object that includes the 3D item. The 3D model may be used to identify different portions of the 3D item that may be printed by different printers 115. In some examples, the 3D model may be provided in the form of a computer aided drawing.

The printing information may include item information identifying the 3D item. The item information may identify a size of the 3D item, a shape of the 3D item, a complexity of the 3D item, a functionality of the 3D item, and/or different portions of the 3D item that may be printed separately. The printing information and/or the item information may identify one or more materials that may be used to print the 3D item.

As shown in FIG. 1A, and by reference number 130, printing segmentation platform 110 may determine a first location, a printer type at the first location, an inventory of filaments at the first location. For example, based on receiving the request, printing segmentation platform 110 may obtain user printing information associated with the user. In some implementation, printing segmentation platform 110 may search a data store that stores information regarding printers 115. Printing segmentation platform 110 may search the data store using information identifying first printer 115-1. The user printer information may identify a first location of first printer 115-1, a first printer type of first printer 115-1, a first inventory of filaments for printing using first printer 115-1, and/or the cloud environment. First printer 115 may be capable of printing a first portion of a three-dimensional item.

As shown in FIG. 1B, and by reference number 135, printing segmentation platform 110 may determine environmental conditions at the first location. For example, based on determining the first location of printer 115-1, printing segmentation platform 110 may determine the environmental conditions at the first locations. In some examples, printing segmentation platform 110 may determine the environmental conditions by obtaining data from one or more devices located at the first location.

The environmental conditions may include a temperature, a level of humidity, a level of dust, and/or a level of electrostatic charge. The one or more devices may include a WiFi thermometer, a wireless remote temperature, a particle counter, other Internet-of-Things devices, among other examples of devices that detect or sense the environmental conditions.

As shown in FIG. 1C, by reference number 140, printing segmentation platform 110 may determine predicted weather condition at the first location. For example, printing segmentation platform 110 may provide one or more queries to one or more sources of weather predictions to obtain weather prediction information for the first location. The one or more sources of weather predictions may include one or more web sites that provide information regarding weather prediction and/or one or more devices of weather data providers.

As shown in FIG. 1C, and by reference number 145, printing segmentation platform 110 may determine additional locations, printer types, inventory of filaments, and environmental conditions at the additional locations. For example, based on receiving the request, printing segmentation platform 110 perform a lookup of the data store to identify additional printers 115 that are included in the cloud environment. For instance, printing segmentation platform 110 may perform the lookup using information identifying the cloud environment. Based on performing the lookup, printing segmentation platform 110 may obtain network information identifying additional printers 115, locations of the additional printers 115, printer types of the additional printers 115, inventories of filament at the locations, and environmental conditions at the locations.

As shown in FIG. 1D, and by reference number 150, printing segmentation platform 110 may determine identify one or more printers to assist with printing the 3D item. In some implementations, printing segmentation platform 110 may identify printers 115 that include in the inventories of filaments, the 3D material for printing the 3D item. Additionally, or alternatively, printing segmentation platform 110 may determine distances between the first location and the locations of the additional printers 115. To facilitate the selection of printers for printing the 3D item, printing segmentation platform 110 may identify printers 115 associated with distances that are within a distance threshold.

In this regard, the one or more printers 115 may be a printer that has the 3D material required to print the 3D item included in an inventory of filaments associated with the printer, and/or that are within the distance threshold. As shown in FIG. 1D, for example, printing segmentation platform 110 may identify second printer 115-2 and third printer 115-3. In some examples, printing segmentation platform 110 may identify a first distance between first printer 115-1 and second printer 115-2, identify a second distance between second printer 115-2 and third printer 115-3, and so on.

Printing segmentation platform 110 may determine that the first distance is within the distance threshold, determine that the second distance is within the distance threshold, and so on. Based on determining that the first distance is within the distance threshold, printing segmentation platform 110 may identify second printer 115-2. Similarly, printing segmentation platform 110 may identify third printer 115-3. In some implementations, the distance threshold may be identified in the request. Additionally, printing segmentation platform 110 may be pre-configured with information identifying the distance threshold.

As shown in FIG. 1D, and by reference number 155, printing segmentation platform 110 may determine different portions of the 3D item to be separately printed by different printers. For example, printing segmentation platform 110 may analyze the item information to identify different portions of the 3D item that may be printed separately. As shown in FIG. 1D, the 3D item may include a first portion and a second portion. In some examples, printing segmentation platform 110 may determine the first portion and the second portion by analyzing the printing information.

As shown in FIG. 1E, and by reference number 160, printing segmentation platform 110 may perform a correlation analysis to determine printing times associated with different combinations of printers printing the 3D item. In some implementations, printing segmentation platform 110 may determine a correlation between the environmental conditions and the speed of print of a printer 115. For example, printing segmentation platform 110 may determine a speed of printing of first printer 115-1 based on the temperature at the first location, determine a speed of printing of second printer 115-2 based on the temperature at the second location of second printer 115-2, and so on. Additionally, or alternatively, printing segmentation platform 110 may determine a quality of printing of first printer 115-1 based on the level of humidity at the first location, determine a quality of printing of second printer 115-2 based on the level of humidity at the second location of second printer 115-2, and so on.

In some implementations, printing segmentation platform 110 may identify different printers 115 to print the different portions of the 3D item. In some examples, printing segmentation platform 110 may identify the different printers 115 based on various factors, such as the printer types of the different printers 115, a level of complexity of each portion, and/or a deadline associated with each portion, among other examples. For example, historical data may indicate that one printer type has frequently been used to print the first portion while another printer type has frequently used to print the second portion. In some implementations, the historical data may provide information regarding previous print jobs. The information regarding the previous print jobs may be analyzed to determine different factors, such as printer types utilized for the previous print jobs, complexities of different portions of the previous print jobs, and/or deadlines associated with the previous print jobs, among other examples.

As another example, a level of complexity of the first portion may indicate that one printer type is more suitable to print the first portion while a level of complexity of the second portion may indicate that another printer type is more suitable to print the second portion. As yet another example, a deadline associated with the first portion may exceed a deadline associated with the second portion and, accordingly, one printer 115 associated with a highest temperature may be used to print the first portion.

As an example, printing segmentation platform 110 may determine that the combination of first printer 115-1 and second printer 115-2 will use a printing time of 3 hours to print the 3D item while the combination of first printer 115-1 and third printer 115-3 will use a printing time of 4.5 hours to print the 3D item. In this regard, printing segmentation platform 110 may identify a first path between the first location and the second location and may identify a second path between the first location and the third location. For example, transportation device 120 may travel the first path or the second path during the printing process of the 3D item. For example, after first printer 115-1 finishes printing a first portion of the 3D item, transportation device 120 may pick up the first portion at the first location and may travel the first path from the first location to the second location. Transportation device 120 may provide the first portion to second printer 115-2 at the second location and second printer 115-2 may continue printing the 3D item by printing a second portion of the 3D item. As an example, printing segmentation platform 110 may determine the printing time, of each combination, by adding the speed of printing of each printer 115 in the combination.

As shown in FIG. 1E, and by reference number 165, printing segmentation platform 110 may determine different costs associated with the different paths. In some implementations, printing segmentation platform 110 may determine different costs associated with the different printing times. In some examples, printing segmentation platform 110 may estimate a path cost based on a type of transportation device 120, a charge duration of transportation device 120, an energy cost at the first location, an energy cost at the second location, among other example. For example, a first type of transportation device 120 may use a first type of battery that would need 4 charges to travel the first path and would need 5 charges to travel the second path.

Accordingly, printing segmentation platform 110 may determine that a first amount of battery consumption associated with transporting the first portion and the second portion between the first location and the second location exceeds a second amount of battery consumption associated with transporting the first portion and the second portion between the first location and the third location. In some instances, based on a distance per charge value, printing segmentation platform 110 may determine that the first path would cost a first amount while the second path would cost a second amount that exceeds the first amount.

As shown in FIG. 1F, and by reference number 170, printing segmentation platform 110 may cause the different portions to be transported between the different locations for printing of the 3D item. For example, printing segmentation platform 110 may cause transportation device 120 to transport the different portions to be transported between the different locations for printing. For instance, printing segmentation platform 110 may receive an indication that first printer 115-1 has completed printing the first portion and that the first portion is provided on a surface area of first printer 115-1 (e.g., a parking area on the print bed).

Based on the indication, printing segmentation platform 110 may provide instructions to transportation device 120 to cause transportation device 120 to pick up the first portion and deliver the first portion to the second location (and more specifically to the print bed of second printer 115-2). Subsequently, second printer 115-2 may resume printing of the 3D item by printing the second portion on the first portion.

By causing the 3D item to be printed as described herein, the system may ensure that the environment the 3D printing process is occurring in a controlled environment. The environment may be controlled by taking into consideration the environmental conditions at the different locations. Accordingly, the speed and the quality of the 3D printing process may be improved and maintained. While implementations are described herein in connection with a 3D printing process, implementations herein may be applicable to fourth-dimensional (4D) printing process.

As indicated above, FIGS. 1A-1F are provided as an example. Other examples may differ from what is described with regard to FIGS. 1A-1F. The number and arrangement of devices shown in FIGS. 1A-1F are provided as an example. A network, formed by the devices shown in FIGS. 1A-1F may be part of a network that comprises various configurations and uses various protocols including local Ethernet networks, private networks using communication protocols proprietary to one or more companies, cellular and wireless networks (e.g., Wi-Fi), instant messaging, Hypertext Transfer Protocol (HTTP) and simple mail transfer protocol (SMTP), and various combinations of the foregoing.

There may be additional devices (e.g., a large number of devices), fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

FIG. 2 is a diagram of an example computing environment 200 in which systems and/or methods described herein may be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 200 contains an example of an environment for the execution of at least some of the computer code involved in performing the inventive methods, such as segmentation analyzing code 250. In addition to block 250, computing environment 200 includes, for example, computer 201, wide area network (WAN) 202, end user device (EUD) 203, remote server 204, public cloud 205, and private cloud 206. In this embodiment, computer 201 includes processor set 210 (including processing circuitry 220 and cache 221), communication fabric 211, volatile memory 212, persistent storage 213 (including operating system 222 and block 250, as identified above), peripheral device set 214 (including user interface (UI) device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244.

COMPUTER 201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

PROCESSOR SET 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored in block 250 in persistent storage 213.

COMMUNICATION FABRIC 211 is the signal conduction path that allows the various components of computer 201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 212 is any type of volatile memory now known or to be developed in the future. Examples include dynamic type random access memory (RAM) or static type RAM. Typically, volatile memory 212 is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

PERSISTENT STORAGE 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices. Operating system 222 may take several forms, such as various known proprietary operating systems or open source Portable Operating System Interface-type operating systems that employ a kernel. The code included in block 250 typically includes at least some of the computer code involved in performing the inventive methods.

PERIPHERAL DEVICE SET 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

NETWORK MODULE 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215.

WAN 202 is any wide area network (for example, the internet) capable of communicating computer data over non-local distances by any technology for communicating computer data, now known or to be developed in the future. In some embodiments, the WAN 202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 203 is any computer system that is used and controlled by an end user (for example, a customer of an enterprise that operates computer 201) and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

REMOTE SERVER 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

PUBLIC CLOUD 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

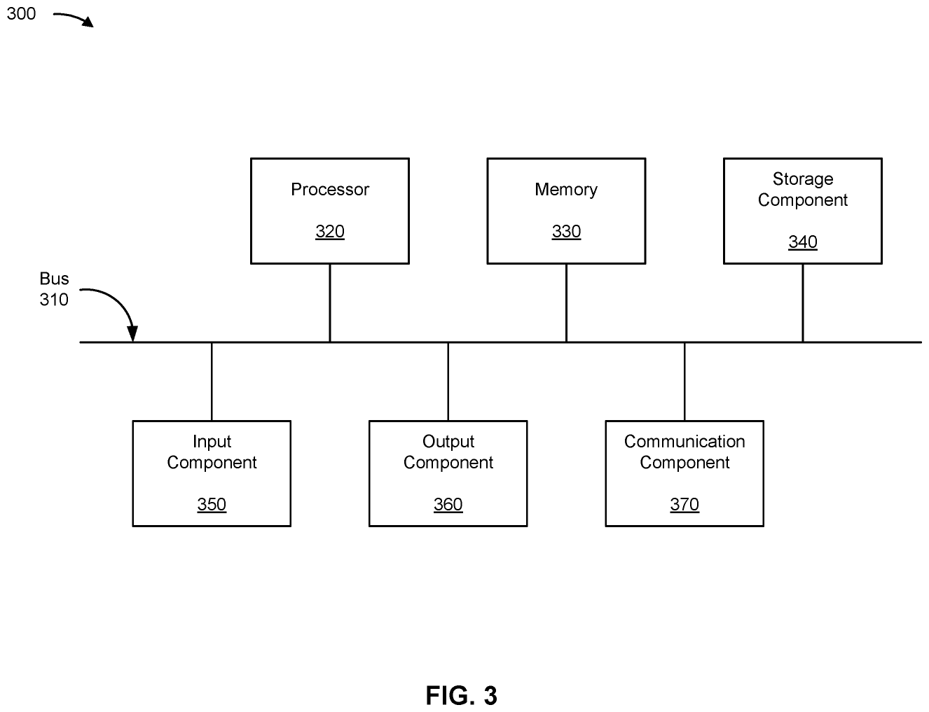

FIG. 3 is a diagram of example components of a device 300, which may correspond to user device 105 and/or printing segmentation platform 110. In some implementations, user device 105 and/or printing segmentation platform 110 may include one or more devices 300 and/or one or more components of device 300. As shown in FIG. 3, device 300 may include a bus 310, a processor 320, a memory 330, a storage component 340, an input component 350, an output component 360, and a communication component 370.

Bus 310 includes a component that enables wired and/or wireless communication among the components of device 300. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform a function. Memory 330 includes a random access memory, a read only memory, and/or another type of memory (e.g., a flash memory, a magnetic memory, and/or an optical memory).

Storage component 340 stores information and/or software related to the operation of device 300. For example, storage component 340 may include a hard disk drive, a magnetic disk drive, an optical disk drive, a solid state disk drive, a compact disc, a digital versatile disc, and/or another type of non-transitory computer-readable medium. Input component 350 enables device 300 to receive input, such as user input and/or sensed inputs. For example, input component 350 may include a touch screen, a keyboard, a keypad, a mouse, a button, a microphone, a switch, a sensor, a global positioning system component, an accelerometer, a gyroscope, and/or an actuator. Output component 360 enables device 300 to provide output, such as via a display, a speaker, and/or one or more light-emitting diodes. Communication component 370 enables device 300 to communicate with other devices, such as via a wired connection and/or a wireless connection. For example, communication component 370 may include a receiver, a transmitter, a transceiver, a modem, a network interface card, and/or an antenna.

Device 300 may perform one or more processes described herein. For example, a non-transitory computer-readable medium (e.g., memory 330 and/or storage component 340) may store a set of instructions (e.g., one or more instructions, code, software code, and/or program code) for execution by processor 320. Processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

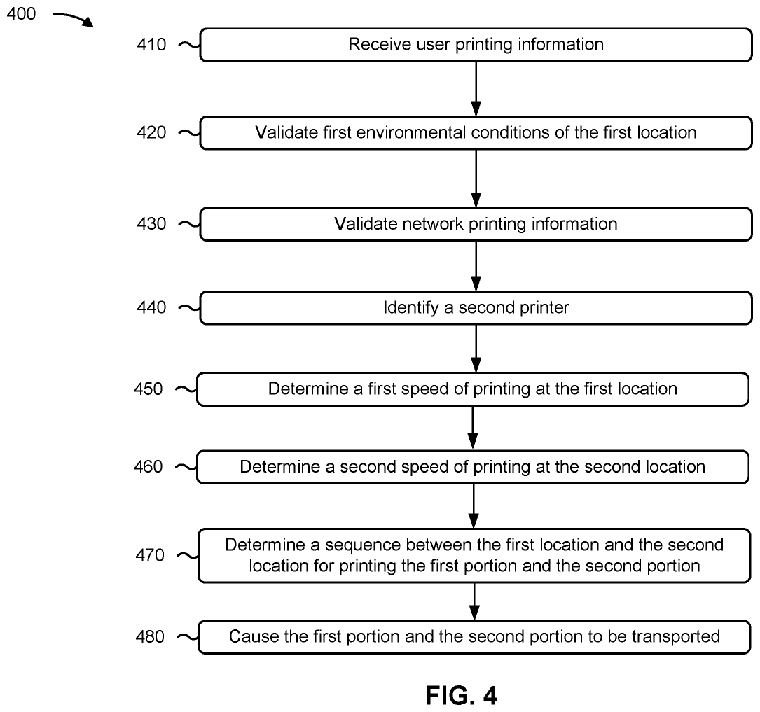

FIG. 4 is a flowchart of an example process 400 associated with 3D printing segmentation based on environmental data. In some implementations, one or more process blocks of FIG. 4 may be performed by a printing segmentation platform (e.g., printing segmentation platform 110). In some implementations, one or more process blocks of FIG. 4 may be performed by another device or a group of devices separate from or including the printing segmentation platform, such as a user device (e.g., user device 105) and/or a transportation device (e.g., transportation device 120). Additionally, or alternatively, one or more process blocks of FIG. 4 may be performed by one or more components of device 300, such as processor 320, memory 330, storage component 340, input component 350, output component 360, and/or communication component 370.

As shown in FIG. 4, process 400 may include receiving user printing information (block 410). For example, the printing segmentation platform may receive user printing information, associated with a first user, that identifies a first location of a first printer capable of printing a first portion of a three-dimensional item, a first printer type of the first printer, and a first inventory of filaments for printing using the first printer, as described above.

As further shown in FIG. 4, process 400 may include validating first environmental conditions of the first location (block 420). For example, the printing segmentation platform may validate first environmental conditions of the first location, that include a first level of humidity and a first temperature at the first location, as described above.

As further shown in FIG. 4, process 400 may include validating network printing information (block 430). For example, the printing segmentation platform may validate network printing information, associated with a plurality of printers in a cloud environment capable of printing three-dimensional items, that identifies locations of the plurality of printers, printer types of the plurality of printers, inventories of filaments for printing with the plurality of printers, and network environmental conditions of the locations, as described above.

As further shown in FIG. 4, process 400 may include identifying a second printer (block 440). For example, the printing segmentation platform may identify a second printer, of the plurality of printers, capable of printing a second portion of the three-dimensional item based on a distance between the first location and a second location of the second printer, the user printing information, the first environmental conditions, and the network printing information, as described above.

In some implementations, process 400 may include receiving item information identifying the item; determining that the first portion is to be printed by the first printer based on the item information, the first printer type of the first printer, and the first inventory of filaments; and determining that the second portion is to be printed by the second printer based on the item information, a second printer type of the second printer identified by the network printing information, and a second inventory of filaments identified by the network printing information. The item information includes a size of the item, a shape of the item, and a complexity of the item.

In some implementations, process 400 may include analyzing the item information to determine a manner for segmenting the item without affecting the functionality of the item; and segmenting the item into the first portion and the second portion based on analyzing the item information.

As further shown in FIG. 4, process 400 may include determining a first speed of printing at the first location (block 450). For example, the printing segmentation platform may determine a first speed of printing at the first location based on the first environmental conditions, as described above.

As further shown in FIG. 4, process 400 may include determining a second speed of printing at the second location (block 460). For example, the printing segmentation platform may determine a second speed of printing at the second location based on the second environmental conditions, as described above.

As further shown in FIG. 4, process 400 may include determining a sequence between the first location and the second location for printing the first portion and the second portion (block 470). For example, the printing segmentation platform may determine a sequence between the first location and the second location for printing the first portion and the second portion based on the first speed of printing and the second speed of printing, as described above.

As further shown in FIG. 4, process 400 may include causing the first portion and the second portion to be transported (block 480). For example, the printing segmentation platform may cause the first portion and the second portion to be transported between the first location and the second location to cause the first portion and the second portion to be printed based on the sequence.

In some implementations, process 400 may include receiving first weather prediction information indicating a first weather predicted at the first location; receiving second weather prediction information indicating a second weather predicted at the second location; and updating the sequence for printing the first portion and the second printing based on the first weather predicted at the first location and the second weather predicted at the second location.

In some implementations, process 400 may include identifying a third printer of the plurality of printers, capable of printing the second portion of the three-dimensional item, based on a second distance between the third printer and the first printer, third environmental conditions at a third location of the third printer, and a second inventory of filaments for printing using the third printer; determining a first printing time and a first amount of battery consumption associated with transporting the first portion and the second portion between the first location and the second location; determining a second printing time and a second amount of battery consumption associated with transporting the first portion and the second portion between the first location and the third location; and causing the first portion and the second portion to be transported between the first location and the second location to cause the first portion and the second portion to be printed based on the first printing time, the first amount of battery consumption, the second printing time, and the second amount of battery consumption. The third environmental conditions and the second inventory of filaments are identified based on the network printing information.

In some implementations, causing the first portion and the second portion to be transported between the first location and the second location to cause the first portion and the second portion to be printed comprises: determining that the second printing time exceeds the first printing time; and causing the first portion and the second portion to be transported between the first location and the second location to cause the first portion and the second portion to be printed determining that the second printing time exceeds the first printing time.

In some implementations, process 400 may include determining a level of environmental contaminants (e.g., dust) at the second location; and identifying the second printer further based on the level of environmental contaminants.

In some implementations, process 400 may include determining a first amount of energy consumption associated with the first printer and the second printer printing the first portion and the second portion; determining a second amount of energy consumption associated with the first printer and the third printer printing the first portion and the second portion; and causing the first portion and the second portion to be transported between the first location and the second location for printing further based on the first printing time and the second printing time.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method for three-dimensional printing segmentation, the computer-implemented method comprising:
receiving user printing information, associated with a first user, that identifies a first location of a first printer capable of printing a first portion of a three-dimensional item, a first printer type of the first printer, and a first inventory of filaments for printing using the first printer;
validating first environmental conditions of the first location, that include a first level of humidity and a first temperature at the first location;
validating network printing information, associated with a plurality of printers in a cloud environment that are capable of printing three-dimensional items, that identifies locations of the plurality of printers, printer types of the plurality of printers, inventories of filaments for printing with the plurality of printers, and network environmental conditions of the locations;
identifying a second printer, of the plurality of printers, capable of printing a second portion of the three-dimensional item based on a distance between the first location and a second location of the second printer, the user printing information, the first environmental conditions, and the network printing information;
determining a first speed of printing at the first location based on the first environmental conditions;
determining a second speed of printing at the second location based on second environmental conditions of the second location;
determining a sequence between the first location and the second location for printing the first portion and the second portion based on the first speed and the second speed; and
causing the first portion and the second portion to be transported between the first location and the second location to cause the first portion and the second portion to be printed based on the sequence.

2. The computer-implemented method of claim 1, further comprising:
receiving first weather prediction information indicating a first weather predicted at the first location;
receiving second weather prediction information indicating a second weather predicted at the second location; and
updating the sequence for printing the first portion and the second printing based on the first weather predicted at the first location and the second weather predicted at the second location.

3. The computer-implemented method of claim 1, further comprising:
identifying a third printer of the plurality of printers, capable of printing the second portion of the three-dimensional item, based on a second distance between the third printer and the first printer, third environmental conditions at a third location of the third printer, and a second inventory of filaments for printing using the third printer,
wherein the third environmental conditions and the second inventory of filaments are identified based on the network printing information;
determining a first printing time and a first amount of battery consumption associated with transporting the first portion and the second portion between the first location and the second location;
determining a second printing time and a second amount of battery consumption associated with transporting the first portion and the second portion between the first location and the third location; and
causing the first portion and the second portion to be transported between the first location and the second location to cause the first portion and the second portion to be printed based on the first printing time, the first amount of battery consumption, the second printing time, and the second amount of battery consumption.

4. The computer-implemented method of claim 3, wherein the first speed of printing of the first printer is determined based on the first level of humidity and the first temperature,
wherein the second speed of printing of the second printer is determined based on a second level of humidity and a second temperature at the second location,
wherein determining the first printing time comprises:
determining the first printing time based on the first speed of printing and the second speed of printing, and
wherein determining the first printing time comprises:
determining a third speed of printing of the third printer based on a third level of humidity and a third temperature at the third location, and
determining the second printing time based on the first speed of printing and the third speed of printing.

5. The computer-implemented method of claim 3, wherein causing the first portion and the second portion to be transported between the first location and the second location to cause the first portion and the second portion to be printed comprises:
determining that the second printing time exceeds the first printing time; and
causing the first portion and the second portion to be transported between the first location and the second location to cause the first portion and the second portion to be printed determining that the second printing time exceeds the first printing time.

6. The computer-implemented method of claim 1, further comprising:
receiving item information identifying the item,
wherein the item information includes a size of the item, a shape of the item, and a complexity of the item;
determining that the first portion is to be printed by the first printer based on the item information, the first printer type of the first printer, and the first inventory of filaments; and
determining that the second portion is to be printed by the second printer based on the item information, a second printer type of the second printer identified by the network printing information, and a second inventory of filaments identified by the network printing information.

7. The computer-implemented method of claim 1, further comprising:
receiving item information identifying the item,
wherein the item information identifies a size of the item, a shape of the item, a complexity of the item, and a functionality of the item;
analyzing the item information to determine a manner for segmenting the item without affecting the functionality of the item; and
segmenting the item into the first portion and the second portion based on analyzing the item information.

8. A computer program product comprising:
one or more computer readable storage media, and program instructions collectively stored on the one or more computer readable storage media, the program instructions comprising:
program instructions to receive user printing information that identifies a first location of a first printer capable of printing a three-dimensional item;
program instructions to determine user environmental conditions, of the first location, that include a level of humidity and a temperature at the first location;
program instructions to identify a second printer, of a plurality of printers in a cloud environment, based on an inventory of filaments at a second location of the second printer and a first distance between the first location and the second location;
program instructions to identify a third printer, of the plurality of printers, based on an inventory of filaments at a third location of the third printer and a second distance between the first location and the third location;
program instructions to determine a first printing time of the first printer and the second printer printing different portions of the three-dimensional item;
program instructions to determine a second printing time of the first printer and the third printer printing different portions of the three-dimensional item; and
program instructions to cause a first portion and a second portion, of the three-dimensional item, to be transported between the first location and the second location for printing based on the first printing time and the second printing time.

9. The computer program product of claim 8, wherein the level of humidity and the temperature is a first level of humidity and a first temperature, and
wherein the program instructions to determine the first printing time comprise:
program instructions to determine a second level of humidity and a second temperature at the second location;
program instructions to determine a first speed of printing of the first printer printing the first portion,
wherein the first speed of printing is determined based on the first level of humidity and the first temperature;
program instructions to determine a second speed of printing of the second printer printing the second portion,
wherein the second speed of printing is determined based on the second level of humidity and the second temperature; and
program instructions to determine the first printing time based on the first speed of printing and the second speed of printing.

10. The computer program product of claim 9, wherein the program instructions to determine the second printing time comprise:
program instructions to determine a third level of humidity and a third temperature at the second location;
program instructions to determine a third speed of printing of the third printer printing the second portion,
wherein the second speed of printing is determined based on the third level of humidity and the third temperature; and
program instructions to determine the second printing time based on the first speed of printing and the third speed of printing.

11. The computer program product of claim 9, wherein the program instructions to determine the second printing time comprise:
program instructions to determine that the second printing time exceeds the first printing time; and
program instructions to cause the first portion and the second portion to be transported between the first location and the second location for printing based on determining that the second printing time exceeds the first printing time.

12. The computer program product of claim 8, wherein the program instructions further comprise:
program instructions to determine a first amount of energy consumption associated with the first printer and the second printer printing the first portion and the second portion;
program instructions to determine a second amount of energy consumption associated with the first printer and the third printer printing the first portion and the second portion; and
program instructions to cause the first portion and the second portion to be transported between the first location and the second location for printing further based on the first printing time and the second printing time.

13. The computer program product of claim 8, wherein the program instructions further comprise:
program instructions to receive item information identifying the item,
wherein the item information identifies a size of the item, a shape of the item, a complexity of the item, and a functionality of the item;
program instructions to analyze the item information to determine a manner for segmenting the item without affecting the functionality of the item; and
program instructions to segment the item into the first portion and the second portion based on analyzing the item information.

14. The computer program product of claim 13, wherein the program instructions further comprise:
program instructions to determine that the first portion is to be printed by the first printer based on the item information, a first printer type of the first printer, and an inventory of filaments at the first location; and
program instructions to determine that the second portion is to be printed by the second printer based on the item information, a second printer type of the second printer, and the inventory of filaments at the second location.

15. A system comprising:
one or more devices configured to:
receive a request associated with a first printer printing a three-dimensional item at a first location;
identify a second printer, capable of printing the three-dimensional item, based on an inventory of filaments at a second location of the second printer and a first distance between the first location and the second location;
identify a third printer, capable of printing the three-dimensional, based on an inventory of filaments at a third location of the third printer and a second distance between the first location and the third location;
determine first environmental conditions at the first location, second environmental conditions at the second location, and third environmental conditions at the third location;
determine a first printing time, of the first printer and the second printer printing different portions of the three-dimensional item, based on the first environmental conditions and the second environmental conditions;
determine a second printing time, of the first printer and the third printer printing different portions of the three-dimensional item, based on the first environmental conditions and the third environmental conditions; and
cause a first portion and a second portion, of the three-dimensional item, to be transported between the first location and the second location for printing based on the first printing time and the second printing time.

16. The system of claim 15, wherein, to determine the first printing time, the one or more devices are configured to:
determine a first speed of printing of the first printer printing the first portion,
wherein the first speed of printing is determined based on the first environmental conditions;
determine a second speed of printing of the second printer printing the second portion,
wherein the second speed of printing is determined based on the second environmental conditions; and
determine the first printing time based on the first speed of printing and the second speed of printing.

17. The system of claim 16, wherein, to determine the second printing time, the one or more devices are configured to:
determine a third speed of printing of the third printer printing the second portion,
wherein the third speed of printing is determined based on the third environmental conditions; and
determine the second printing time based on the first speed of printing and the third speed of printing.

18. The system of claim 15, wherein the one or more devices are further configured to:
receive item information identifying the item,
wherein the item information identifies a size of the item, a shape of the item, a complexity of the item, and a functionality of the item;
analyze the item information to determine a manner for segmenting the item;
segment the item into the first portion and the second portion based on analyzing the item information;
determine that the first portion is to be printed by the first printer based on the item information, a first printer type of the first printer, and a first inventory of filaments; and
determine that the second portion is to be printed by the second printer based on the item information, a second printer type of the second printer, and a second inventory of filaments.

19. The system of claim 18, wherein the one or more devices, to identify the second printer, are configured to:
determine a level of environmental contaminants at the second location; and
identify the second printer further based on the level of environmental contaminants.

20. The system of claim 15, wherein the one or more devices are further configured to:
receive first weather prediction information indicating a first weather predicted at the first location;
receive second weather prediction information indicating a second weather predicted at the second location; and
update a sequence for printing the first portion and the second printing based on the first weather predicted at the first location and the second weather predicted at the second location.
